(19) United States
(12) Patent Application Publication
(10) Pub. No.: US 2010/0232937 A1
(43) Pub. Date: Sep. 16, 2010

(54) CHARGING DEVICE, MORE PREFERABLY FOR A MOTOR VEHICLE, WITH A VARIABLE TURBINE GEOMETRY

(76) Inventors: Andreas Wengert, Auenwald (DE); Timo Tries, Schwieberdingen (DE); Matthias Stein, Korntal-Muenchingen (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/718,217

(22) Filed: Mar. 5, 2010

(30) Foreign Application Priority Data
Mar. 6, 2009 (DE) DE102009012 065.3

(51) Int. Cl. F02B 33/40; F04D 29/46

(52) U.S. Cl. 415/160

(57) ABSTRACT

The invention relates to a charging device, more preferably a turbocharger, with a spring for clamping the guide blade carrier (9) against a stop device arranged opposite the spring such as for example a plurality of spacer elements (12) or the like. Particularly advantageous is the use of a cantilever spring (3), as a result of which a region of high thermal load of the cantilever spring (3) can be separated from a region of high mechanical load.

The present invention relates to a charging device, more preferably for a motor vehicle, with a variable turbine geometry clamped by a spring.

On a charging device with a variable turbine geometry a guide blade carrier of the variable turbine geometry, in which a plurality of guide blades are rotatably mounted with their blade bearing pins, can be clamped through a disc spring against components surrounding the guide blade carrier in the charging device. Here it is possible that the disc spring acts on an inner ring-shaped region of the guide blade carrier orientated towards a through-opening of the guide blade carrier. In this case a force flow generated through the disc spring is passed on via spacer elements or webs in an outer region orientated towards the outer marginal region of the guide blade carrier. Since the force of the disc spring acts radially unsymmetrically orientated towards an inner marginal region of the guide blade carrier the guide blade carrier is deformed through the action of the disc spring.

Disadvantageous in this design is that because of the deformation of the guide blade carrier the guide blades have to be arranged with enlarged play. Because of the enlargement of the play of the guide blades the performance and the efficiency of the variable turbine geometry is reduced, otherwise a failure risk is increased.

The present invention now deals with the problem of stating an improved or at least another embodiment for a charging device with a variable turbine geometry clamped through a spring which is characterized by greater performance, higher efficiency and reduced failure risk.

According to the invention, this object is solved through the subject of the independent claim 1. Advantageous embodiments are the subject of the dependent claims.

The invention is based on the general idea of using a cantilever spring with at least two bending legs instead of a disc spring for clamping the guide blade carrier against at least one component of the charging device surrounding the guide blade carrier. Through the plurality of bending legs this cantilever spring acts like a beam spring. The use of such a cantilever spring makes possible that the force of the cantilever spring, via its bending legs, can act in an outer region orientated towards the outer marginal region of the guide blade carrier. Because of this, a design with high flexibility can be achieved wherein the pitch circle diameter of the contact points of the cantilever spring is greater or smaller than the pitch circle diameter of the bearing points for the guide blades or corresponds to the latter. Thus the deformation and the induced stress of the guide blade carrier are lower with identical spring force and consequently the axial play of the guide blades mounted in the guide blade carrier via the guide blade pins can be reduced. Because of this, in turn, the performance and the efficiency of the variable turbine geometry are increased. A further advantage in the use of the cantilever spring lies in the enlargement of the distance between a support region of the spring on the guide blade carrier and the support region for example on a bearing housing. On the bearing housing a thermal load is less than on the guide blade carrier. Thus, the further apart the two support regions of the cantilever spring are located, the further can the region of high thermal load and high mechanical load in the spring be separated from each other. This also results in a longer life expectation and a reduced failure risk.

A cantilever spring with a plurality of bending legs is to have a curvature in a first direction with at least two of the bending legs. In addition it is possible that at least two further such bending legs form a curvature in an opposite direction. Through such a cantilever spring it is possible to shift the differently orientated support regions of the cantilever spring towards the free ends of the bending legs. This has the advantage that the support regions of the bending legs, which curve away from the guide blade carrier, are shifted towards an even cooler region. This in turn increases the lifespan of the cantilever spring.

In addition it is possible to arrange a plurality of cantilever springs, whose bending legs form a curvature in only one direction, stacked on top of one another. Here, the bending legs of the cantilever spring can be arranged covered and/or partially overlapping and/or offset. Through such an arrangement stacked on top of one another a wide range of characteristic curves and characteristics of an entire spring arrangement can be realised depending on requirement and application. Because of this, a multitude of spring arrangements can be flexibly realised with few basic embodiments of the cantilever spring.

For stiffening, such cantilever springs can be provided with at least one stiffening such as for example a curvature, a rib, an up-fold, a profiling, a flange edge or the like through offsetting, folding, bending, flanging, metal working, deep drawing, ribbing, welding or the like. Through such stiffenings it is possible to produce bending springs of a same material but with different flexural strengths.

Further important features and advantages of the invention are obtained from the subclaims, from the drawings and from the corresponding figure description by means of the drawings.

It is to be understood that the features mentioned above and still to be explained in the following cannot only be used in the respective combination stated but also in other combinations or by themselves, without leaving the scope of the present invention.

Preferred exemplary embodiments of the invention are shown in the drawings and are explained in more detail in the following description, wherein same reference characters relate to same or similar or functionally same components.

It shows, in each case schematically:

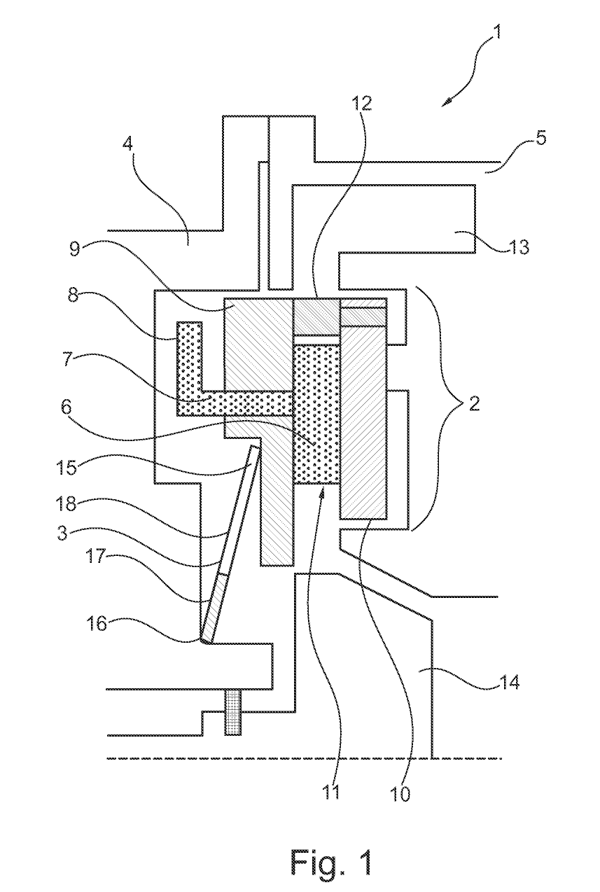

FIG. 1 a cross section through a charging device in the region of the variable turbine geometry with a cantilever spring in installation position,

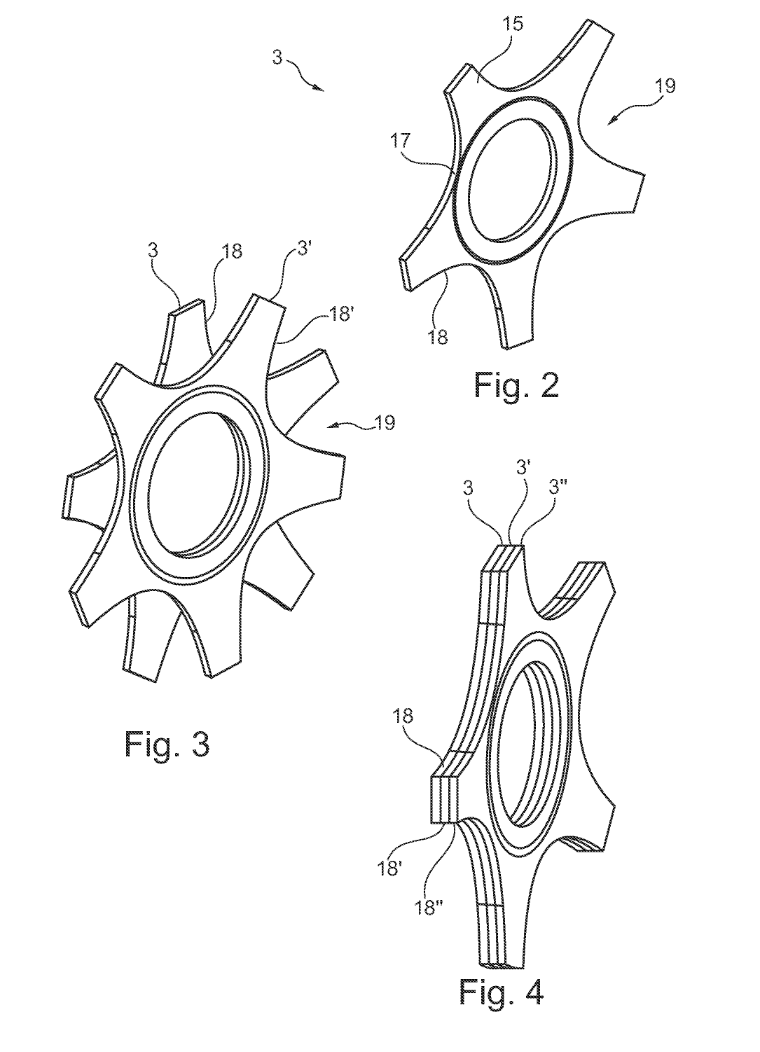

FIG. 2 a top view of the cantilever spring,

FIG. 3 two cantilever springs stacked on top of each other with bending legs arranged offset,

FIG. 4 a plurality of cantilever springs stacked on top of one another with bending legs arranged covered,

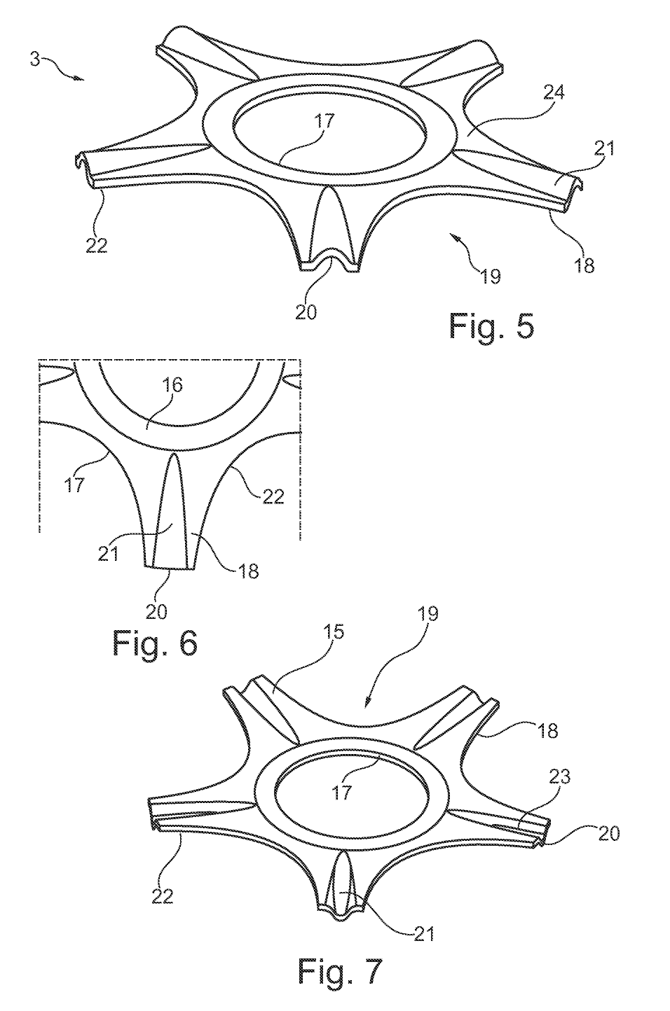

FIG. 5 a top view of an outer side of a curvature of the cantilever spring formed through the bending legs each with a profiling in the bending legs,

FIG. 6 an enlarged detail of the top view of the outer side of the curvature of the cantilever spring formed through the bending legs each with a profiling in the bending legs,

FIG. 7 a top view of the inner side of the curvature of the cantilever spring formed through the bending legs each with a profiling in the bending legs,

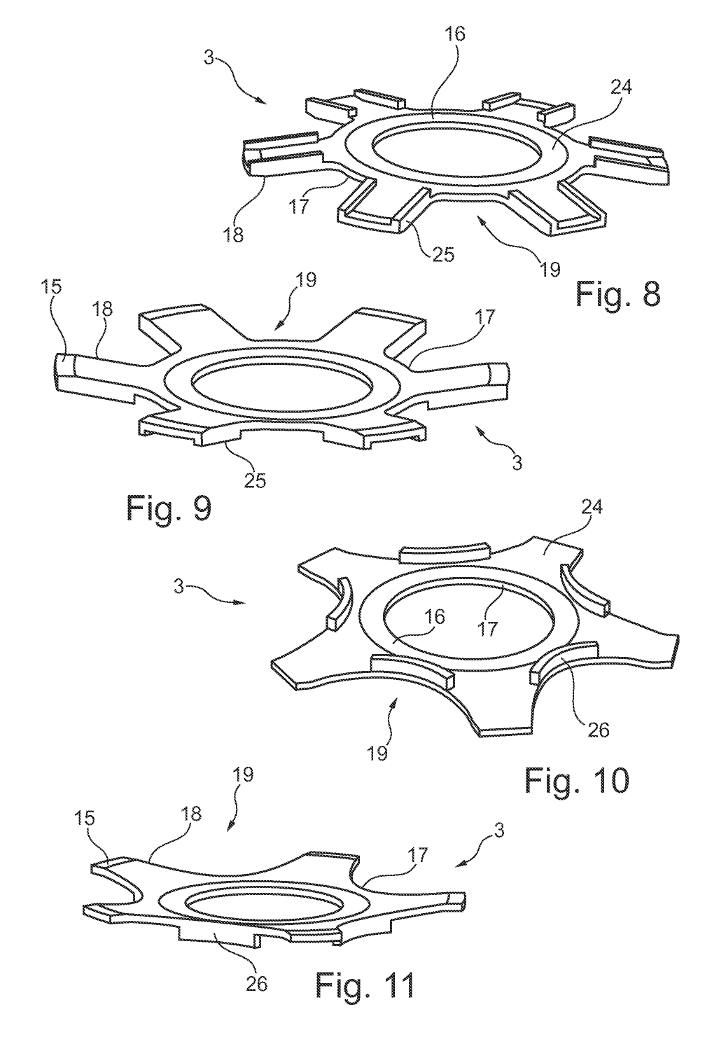

FIG. 8 a top view of the outer side of the curvature of the cantilever spring formed through the bending legs with up-folds on the bending legs,

FIG. 9 a top view of the inner side of the curvature of the cantilever spring formed through the bending legs with up-folds on the bending legs,

FIG. 10 a top view of the outer side of the curvature of the cantilever spring formed through the bending legs with up-folds in the region between two consecutive bending legs,

FIG. 11 a top view of the inner side of the curvature of the cantilever spring formed through the bending legs with up-folds in the region between two consecutive bending legs,

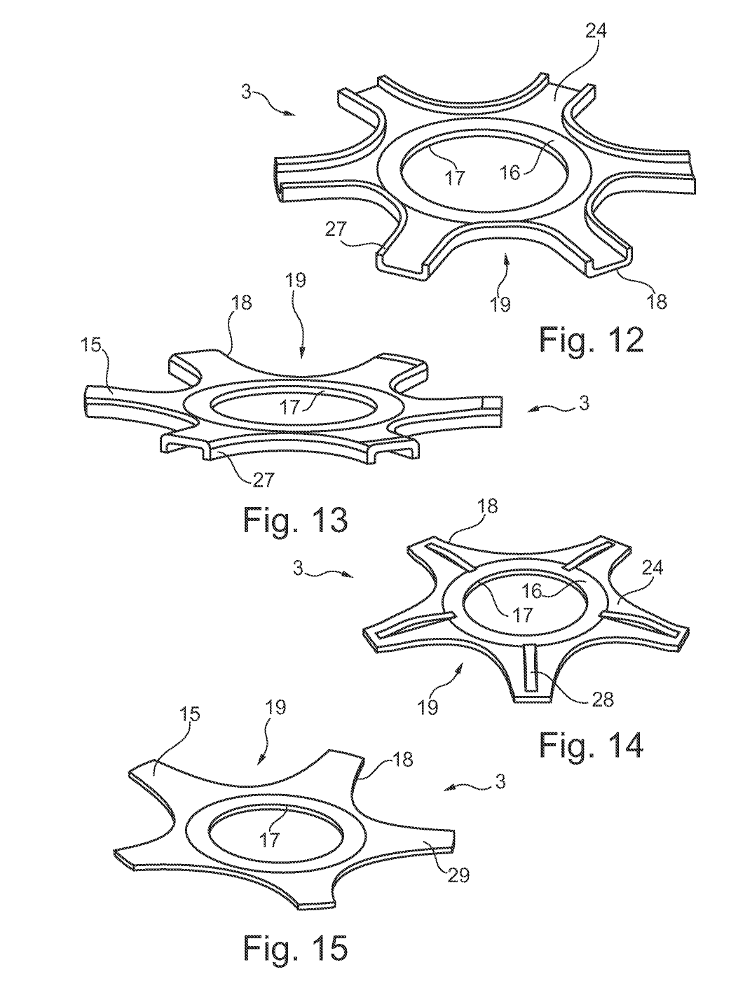

FIG. 12 a top view of the outer side of a curvature of the cantilever spring formed through the bending legs with continuous up-folds on the bending legs and in the region between two consecutive bending legs,

FIG. 13 a top view of the inner side of a curvature of the cantilever spring formed through the bending legs with continuous up-folds on the bending legs and in the region between two consecutive bending legs,

FIG. 14 a top view of the outer side of a curvature of the cantilever spring formed through the bending legs with an outside rib in the bending leg,

FIG. 15 a top view of the inner side of a curvature of a cantilever spring formed through the bending legs with an outer rib in the bending legs,

FIG. 1 shows a charging device 1 with a variable turbine geometry 2 in installation position with a cantilever spring 3. The variable turbine geometry 2 is surrounded by a bearing housing section 4 and a turbine housing section 5 and substantially comprises a plurality of guide blades 6, which are connected in a rotationally fixed manner with a guide blade bearing pin 7 and an adjusting lever 8 each and with the guide blade bearing pins 7 are rotatably mounted in a guide blade carrier 9. Here, the guide blades 6 are arranged in a radial gap 11 formed through the guide blade carrier 9 and a cover disc 10, wherein the height of a radial gap 11 is determined through a plurality of spacer elements 12. An exhaust gas inflow channel 13 directs hot exhaust gas into the radial gap 11, wherein through the position of the guide blades 6 the exhaust gas inflow on to a turbine 14 can be regulated. The height of the radial gap 11 is dimensioned so that a play of the guide blades 6 between the guide blade carrier 9 and the guide blades 6 and between the guide blades 6 and the cover disc 10 makes possible turning of the guide blades 6. The greater the play of the guide blades 6, the lower the resultant performance and efficiency of the variable turbine geometry.

In a preferred embodiment the cantilever spring 3 is provided with support surfaces 15 orientated towards the guide blade carrier 9 and with a support surface 16 of a body 17 of the cantilever spring 3 orientated towards the bearing housing section 4. Through clamping the cantilever spring 3 in installation position, the clamping force of the cantilever spring 3 acts on the guide blade carrier 9 on the support surfaces 15. The further the support surfaces 15 are shifted away from the guide blade bearing pins 7 towards the turbine 14, the more is the guide blade carrier 9 deformed through the clamping forces of the cantilever spring 3. The greater the deformation of the guide blade carrier 9, the greater the play of the guide blades has to be created. A substantial advantage of the cantilever spring 3 is that in contrast with a disc spring the support surfaces 15 can be more easily shifted in the direction of the spacer elements 12 through suitable shaping of the cantilever spring 3. Thus, by using a cantilever spring 3 the clamping force acting on the guide plate carrier 9 can be better distributed and the lesser occurring deformations allow a reduced configuration of the play of the guide blades. As a consequence, a variable turbine geometry 2 equipped with such a cantilever spring 3 has a substantially longer lifespan, a greater thermodynamic efficiency and better adaptability of the characteristic curve of the variable turbine geometry to a respective requirement. In contrast with the disc spring, which has high stresses both on the support surface orientated toward the bearing housing section 4 as well as on the support surface orientated towards the guide blade carrier 9, wherein the support surface orientated towards the bearing housing compared with the support surface orientated towards the guide blade carrier 9 is subjected to comparatively little thermal load, the mechanical loads with the cantilever spring 3 can be shifted in the direction of the support surface 16, as a result of which with the cantilever spring 3 the regions of high mechanical and high thermal load can be separated from each other. Through this separation of the different load regions the cantilever spring 3 compared with a disc spring has a greater life expectation and the cantilever spring 3 can additionally be subjected to greater clamping force.

In a further embodiment it is conceivable that instead of between the guide blade carrier 9 and the bearing housing section 4 the cantilever spring 3 is arranged between the turbine housing section 5 and the cover disc 10. Analogous arrangements in the case of a variable turbine geometry on a compressor side are likewise possible. It is likewise conceivable that the support surfaces 15 are orientated towards the bearing housing section 4 and, for example with a corresponding reduction of the through-opening of the guide blade carrier 9, the support surface 16 towards the guide blade carrier 9.

In a further embodiment a plurality of bending legs 18 of the cantilever spring 3 can be orientated towards the guide blade carrier 9, while a plurality of additional bending legs 18 is orientated towards the bearing housing section 4. In this case the support surfaces 15 abut both the guide blade carrier 9 as well as the bearing housing section 4 while the support surface 16 in this case is no longer necessary. This embodiment of a cantilever spring can be realised through a single cantilever spring or through cantilever springs placed on top of one another which with respect to the curvature of the respective cantilever spring 3 are orientated in an opposite manner so that the support surfaces 16 of the cantilever springs 3 lie on top of one another.

In a possible embodiment as shown in FIG. 2 the cantilever spring 3 is equipped with the body 17 and five bending legs 18 each of which comprise the support surfaces 15 at the end. The bending legs 18 of such a cantilever spring 3 are orientated in such a manner that they form a curvature 19 orientated towards one direction. Generally the cantilever spring 3 can be designed in such a manner that a ratio of an outer diameter of the cantilever spring 3 on the bending leg 18 to an outer diameter of the body 17 is 1.25.

As shown in FIGS. 3 and 4, a cantilever spring 3 formed in this way can be arranged stacked on top of one another, wherein the curvatures 19 of the cantilever springs 3, 3′, 3″ are orientated in the same direction. Here it is possible that the cantilever springs 3, 3′ are stacked on top of each other with bending legs 18, 18′ arranged offset or that the cantilever springs 3, 3′, 3″ are stacked on top of one another with covered bending legs 18, 18′, 18″. Not shown is an arrangement of a plurality of cantilever springs which are orientated in various directions.

A further preferred embodiment of a cantilever spring 3, according to FIGS. 5, 6 and 7, has a profiling 20 on the bending legs 18, wherein the profiling 20 formed as a rib 21 can for example be embodied through a deep drawing tool. Such a cantilever spring 3, on a free end of the bending legs 18, can each comprise a tapering 22. As is evident from FIG. 7, the profiling 20 formed as a rib 21 can have a curvature 23 whose opening faces in the direction of the opening of the curvature 19 formed through the bending legs 18. Through such a type of profiling greater stiffness and thus greater clamping force of the bending legs 18 can be created in the bending legs.

A detail of the top view of an outer side 24 of the curvature 19 shown in FIG. 6 shows a possibility of forming the support surface 16 which the body 17 comprises. Such a support surface 16 can also be configured in the embodiments so far described or in those that follow.

A further preferred embodiment according to FIGS. 8 and 9 comprises a plurality of up-folds 25 on the bending legs 18 which are folded-up in the direction of the outer side 24 of the curvature 19. With this embodiment, too, it is possible to form a support surface 16 on the body 17 and support surfaces 15 on the free end of the bending legs 18.

Another possibility of a stiffening through up-folds is shown in FIGS. 10 and 11. In this embodiment a plurality of up-folds 26 are likewise orientated in the direction of the outer side 24 of the curvature 19 of the cantilever spring 3, however not on the bending legs 18 as in the preceding embodiment, but on an outer side of the body 17.

The embodiment of a cantilever spring 3 shown in FIGS. 12 and 13 combines the two embodiments of FIGS. 8 to 11 last described. This embodiment comprises a plurality of continuous up-folds 27 each of which extends from a corner on the free end of the bending leg 18 via the outer side of the body 17 arranged between two neighbouring bending legs 18 to a corner on the free end of the neighbouring bending leg 18. These up-folds 27 are likewise orientated towards the outer side 24 of the curvature 19.

A further embodiment shown in FIGS. 14 and 15 comprises on the outer side 24 a rib 28 arranged in the middle in the bending legs which for example is shaped through deep drawing or has been subsequently welded on. In this embodiment, no deformations or profilings whatsoever are formed on an inner side 29 of the curvature 19 of the cantilever spring 3.

It is to be understood that another embodiment of such a cantilever spring 3 can be equipped with curvatures, ribs, up-folds, profilings, flange rims or the like formed through offsetting, folding, bending, flanging, metal working, deep drawing, ribbing, welding or the like so that through such stiffening the cantilever spring 3 is equipped with a greater flexural strength.

1. A turbocharging device comprising:
a variable turbine configured in a ring-shape having a radial gap, wherein gases flow through the radial gap;
a guide blade carrier forming a first radial wall of the radial gap; and
at least one spring for clamping the guide blade carrier against a stop device arranged opposite the spring,
wherein at least one spring is a cantilever spring with at least two bending legs.

2. The turbocharging device according to claim 1, wherein at least two of the bending legs have a curvature in one direction.

3. The turbocharging device according to claim 1, wherein at least two of the bending legs have a curvature in a first direction, while at least two of the bending legs have a curvature in an opposite direction.

4. The turbocharging device according to claim 1, wherein at least two of the cantilever springs are arranged stacked on top of each other and are configured to clamp the guide blade carrier against the stop device.

5. The turbocharging device according to claim 1, wherein at least two of the cantilever springs are installed such that the bending legs of the cantilever springs are at least one of covered, partially overlapping and offset.

6. The turbocharging device according to claim 1, wherein at least one of the cantilever springs is arranged between at least one of a housing section and the guide blade carrier, wherein the housing section is at least one of a compressor housing section, a bearing housing section and a turbine housing section, and wherein at least one of the cantilever springs, having at least one free end, and at least two of the bending legs that are curved towards each other, are orientated towards at least one of the guide blade carrier and towards the housing section.

7. The turbocharging device according to claim 6, wherein at least one of the bending legs includes a free end, which comprises a support surface that abuts at least one of the guide blade carrier, a second radial wall of the radial gap and the housing section.

8. The turbocharging device according to claim 1, wherein at least one of the bending legs tapers in the direction of a free end of the bending leg.

9. The turbocharging device according to claim 1, wherein at least one cantilever spring is equipped with a perforated ring-shaped body to which the bending legs are tied and which has a central and circular through-opening.

10. The turbocharging device according to claim 6, wherein the body of the cantilever spring is equipped with a support surface with which the body abuts at least one of the guide blade carriers, the second radial wall and the housing section in a flat manner.

11. The turbocharging device according to claim 1, wherein at least one cantilever spring is provided with at least one stiffening element for increased flexural strength, wherein the stiffening element is at least one of a curvature, a rib, an up-fold, a profiling and a flange rim.

12. The turbocharging device according to claim 11, wherein at least one of the body, at least two bending legs and at least one stiffening element are formed in one piece.

13. The turbocharging device according to claim 9, wherein the cantilever spring comprises at least one of up-fold stiffening element and a flange rim stiffening element on the edges of at least one of at least one bending leg and an outer edge of the body.

14. The turbocharging device according to claim 11, wherein at least one bending leg comprises at least one rib stiffening element and profiling stiffening element positioned in the middle on the bending leg.

15. The turbocharging device according to claim 11, wherein the cantilever spring comprises at least one stiffening element on at least one of the inner side and the outer side of a curvature determined through at least two bending legs.

16. The turbocharging device according to claim 1, wherein stop device is in the form of at least one spacer element.

17. The turbocharging device according to claim 7, wherein a perforated ring-shaped body of the cantilever spring is equipped with a support surface with which the body abuts at least one of the guide blade carrier, the second radial wall and the housing section in a flat manner.

18. The turbocharging device according to claim 9, wherein the body of the cantilever spring is equipped with a support surface with which the body abuts at least one of the guide blade carrier, the second radial wall and the housing section in a flat manner.

19. The turbocharging device according to claim 9, wherein at least one of the body, at least two bending legs and at least one of a flexural strength stiffening element are formed in one piece

20. The turbocharging device according to claim 10, wherein at least one of the body, at least two bending legs and at least one of a flexural strength stiffening element are formed in one piece
